(19) United States
(12) Patent Application Publication
(10) Pub. No.: US 2023/0032777 A1
(43) Pub. Date: Feb. 2, 2023

(54) Temperature Management Module with Pump and Central Control Device

(71) Applicant: NIDEC GPM GMBH, Auengrund OT Merbelsrod (DE)

(72) Inventor: Franz PAWELLEK, Lautertal (DE)

(73) Assignee: NIDEC GPM GMBH, Auengrund OT Merbelsrod (DE)

(21) Appl. No.: 17/874,101

(22) Filed: Jul. 26, 2022

(30) Foreign Application Priority Data
Jul. 28, 2021 (DE) 102021119571.3

(51) Int. Cl. B60K 11/02; F04B 17/03

(52) U.S. Cl. CPC B60K 11/02; F04B 17/03

(57) ABSTRACT

Pump module, particularly for a temperature management system, and temperature management system comprising the pump module, and motor vehicle comprising the pump module or the temperature management system

The invention relates to a pump module, in particular a liquid fluid pump module for a temperature management system (100), e.g. of an electric battery-driven motor vehicle or a hybrid motor vehicle, comprising:
at least one electrically driven fluid pump unit (2) which is configured and provided to supply fluid to be pumped to at least one actuatable fluid valve means (3);
a control device (ECU) for actuating at least one drive motor (7) of the fluid pump unit (2), wherein the control unit (ECU) also comprises at least one electrically actuatable operating solenoid (31) for a pilot valve (20), which solenoid is configured and provided to hydraulically operate the fluid valve means (3) by means of the pilot valve (20) during normal use of the pump module (1).

Furthermore, the invention relates to a temperature management system comprising the pump module, and a motor vehicle comprising the pump module or the temperature management system.

### FIELD OF INVENTION

Pump module, particularly for a temperature management system, and temperature management system comprising the pump module, and motor vehicle comprising the pump module or the temperature management system.

The invention relates to a pump module according to the preamble of claim 1, and a temperature management system comprising the pump module, and a motor vehicle comprising the pump module or the temperature management system.

Pump modules are used in modern vehicles e.g. in temperature management systems for controlling the temperature of internal combustion drives and/or electric drives. The aim is to achieve the highest possible functional integration of individual components, in particular integration of functions in temperature management systems in cooling modules.

Such cooling modules typically, but not exclusively or necessarily, comprise the following components:
a low-temperature pump which is configured and provided to circulate a low-temperature temperature control fluid. The low-temperature fluid is typically at a temperature of up to 40° C. and is used e.g. to cool batteries;
a high-temperature pump which is configured and provided to circulate a high-temperature temperature control fluid. The high-temperature fluid is typically at a temperature of up to 120° C. and is used e.g. in electric battery-operated vehicles to cool an inverter and/or a drive. In vehicles with an internal combustion engine, e.g. such a high-temperature pump can be used to circulate a cooling fluid for an internal combustion engine. In addition to the function of circulating a temperature control fluid of any type, fluids of another type, in particular lubricating fluids, such as e.g. transmission oil, can also be circulated;
an electric rotary slide valve, up to six solenoid valves and—where necessary—temperature sensors, coolant level sensors and the like.
If the cooling module contains a coolant-cooled condenser, it may be expedient to use an expansion valve.

In temperature management systems according to the prior art, for each electric component, a connection plug is used so that each electric component has its own connection and must be electrically contacted individually during assembly. The necessary contacting work results in many expensive electric plug connections and requires a particularly high-cost cable harness for cabling purposes. The production of many electric plug connections is very complex in terms of assembly and can be error-prone.

An object of the invention is thus to provide a pump module which permits a reduction in the electric contacting work and therefore reduces the number of plug connections and assembly costs. Furthermore, a pump module in accordance with the invention should render possible a relatively simple connection cable harness for electric contacting thereof.

It is also an object of the invention to provide a temperature management system for the avoidance of the above-mentioned disadvantages.

Furthermore, it is an object of the invention to provide a motor vehicle which has an optimised pump module, in particular an optimised temperature management system.

The above-mentioned objects are achieved with a pump module having the features of claim 1. Advantageous embodiments are given in the dependent claims. With respect to the temperature management system, the above-mentioned objects are achieved with a temperature management system having the features of claim 12. With respect to the motor vehicle-specific objects, these are achieved with a motor vehicle having the features of claim 13.

A pump module in accordance with the invention, in particular a liquid fluid pump module for a temperature management system, e.g. of a electric battery-driven motor vehicle or of a hybrid motor vehicle comprises:
at least one electrically driven fluid pump unit which is configured and provided to supply fluid to be pumped to at least one actuatable fluid valve means;
a control unit (ECU) for actuating at least one drive motor of the fluid pump unit.

### SUMMARY OF INVENTION

In accordance with the invention, such a pump module is further developed in that the control unit ECU also comprises at least one electrically actuatable operating solenoid for a pilot valve, which solenoid is configured and provided to hydraulically operate the fluid valve means by means of the pilot valve during normal use of the pump module.

With such a pump module in accordance with the invention it is possible to achieve an increased functional integration in that the control unit of the pump module is trained, e.g. to operate temperature control fluid valve means hydraulically and integrally comprises solenoids to be actuated accordingly.

Such a pump module enables the possibility to be created of centrally actuating necessary fluid valves, e.g. temperature control fluid valves, wherein, by means of the hydraulic actuation, in particular electric plug connections, which form part of the assembly process of a cooling module, e.g. of a temperature management system, can be avoided. The reduction in the electric plug contacts is also achieved in particular in that the at least one electrically actuatable operating solenoid is integrated into the control unit and therefore comprises no separate plug contact to be connected to a cable harness.

In one particular embodiment of the pump module in accordance with the invention, the fluid is a liquid fluid which is used as a temperature control fluid in a temperature management system for the purposes of cooling components.

The pump module in accordance with the invention is particularly but not exclusively suitable for such use. In an embodiment of this type, the fluid pump unit acts as a temperature control fluid pump unit.

In one particular embodiment, the pump module is characterized in that an additional pump assembly is provided which provides a control fluid having a control pressure.

In such a pump module, a control fluid necessary to the operation of e.g. temperature control fluid valve means can already be provided also in a highly integrated manner without separate cabling being required.

Furthermore, for this purpose it can be advantageous for the additional pump assembly to be able to be driven by the drive motor of the fluid pump unit.

In this way, a particularly highly integrated construction is also achieved. One drive motor is sufficient to drive both the fluid pump unit and also an additional pump assembly. Furthermore, such a design reduces the cabling outlay.

Furthermore, it can be advantageous for the additional pump assembly to be able to be driven by a free end of a drive shaft of the fluid pump unit.

By this means it is particularly easy to provide a way of driving the additional pump assembly using a small number of components.

Furthermore, it can be advantageous for the control fluid to be the fluid to be pumped and to be able to be branched off from a fluid volume flow.

It is thereby possible to avoid having to provide a separate hydraulic circuit for the hydraulic actuation of the fluid valve means.

Furthermore, it may be advantageous that for branching off the control fluid there is a flow channel leading from a pump chamber of the fluid pump unit to the additional pump assembly.

A branch directly from a pump chamber of the fluid pump unit makes it possible to channel fluid to the additional pump assembly particularly easily, in particular lines which are accordingly necessary for this purpose can be integrated e.g. into a pump housing of the fluid pump unit.

In order to produce the pump module in accordance with the invention in a particularly highly integrated manner it may be advisable for the at least one operating solenoid to be mounted directly on a control board of the control unit by means of SMD mounting technology.

With such SMD (surface-mount device) mounting technology, electric components can be mounted on a board in a particularly cost-effective and highly integrated manner. In the case of this embodiment in accordance with the invention, corresponding SMD mounting is effected for the operating element which is to be operated electrically, i.e. for the operating solenoid of the pilot valve means in this technology.

It may also be expedient for the pump module to comprise at least one fluid pump unit, which is designed as a low-temperature pump, particularly for the cooling of a battery cooling circuit, and to comprise a fluid pump unit which is designed as a high-temperature pump, particularly for cooling an inverter or a drive of a motor vehicle.

With such a division of functions, multi-circuit cooling systems can be supplied using the pump module in accordance with the invention.

In particular, a fluid pump unit which is designed as an orbiter eccentric piston pump has proved to be particularly suitable as a fluid pump unit for a pump module in accordance with the invention.

Such a pump comprises, on the one hand, components which cooperate with low levels of internal friction and low surface pressures so that, on the one hand, a high level of overall efficiency can be achieved and, on the other hand, particularly favourable manufacturing is possible, e.g. manufacturing of all essential pump components, such as e.g. of a pump chamber or of an orbiter eccentric piston, from synthetic material. Such orbiter eccentric piston pumps in the form of vacuum pumps for evacuation of gaseous media are known. In the present case, it is particularly surprising in the invention that by means of an orbiter eccentric piston pump for delivery of liquid fluids, e.g. temperature control fluids or lubricating fluids, particularly high levels of efficiency can be achieved. This is especially the case against the background of low production costs and easy assembly.

It is also advantageous that all fluid pump units are disposed so as to be coaxially drivable, in particular also together with the additional pump assembly, about a common drive axis A.

In this way, all pump units of the pump module can be driven by means of a single drive motor.

A temperature management system in accordance with the invention comprises at least one pump module in accordance with the invention and at least one fluid valve means which can be operated by at least one pilot valve which can be operated by at least one operating solenoid.

A motor vehicle in accordance with the invention comprises a pump module in accordance with the invention or a temperature management system in accordance with the invention.

### BRIEF DESCRIPTION OF THE DRAWINGS

The invention will be described in more detail by way of example hereinunder with the aid of the drawing. The single FIGURE shows:

FIG. 1: in a highly schematic manner, a temperature management system in accordance with the invention, comprising a pump module in accordance with the invention for use in a motor vehicle, in particular in an electric battery-operated motor vehicle, with a partially cut-away longitudinal cross-sectional view of fluid pump units designed as temperature control fluid pump units, in a two-row orbiter eccentric piston construction.

### DESCRIPTION OF EMBODIMENTS

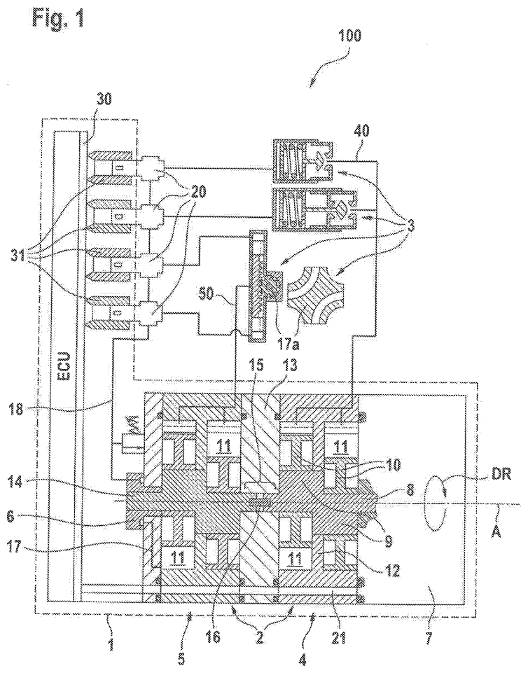

In an exemplified embodiment according to FIG. 1 described hereinunder, the pump module 1 in accordance with the invention is described with reference to use in a schematically illustrated temperature management system 100. Fluid pump units 2 are designed as temperature control fluid pump units therein. The fluid valve means 3 are designed as temperature control fluid valve means. The temperature control fluid pump units 2 deliver a liquid temperature control fluid.

In the exemplified embodiment, the temperature control fluid pump unit 2 has a high-temperature pump 4 for delivery of a temperature control fluid at a relatively high temperature, e.g. up to 120° C. The high-temperature pump 4 is illustrated as a two-row orbiter eccentric piston pump in the exemplified embodiment according to FIG. 1. In the exemplified embodiment according to FIG. 1, the other temperature control fluid pump unit 2 is designed as a low-temperature pump 5 for delivery of a temperature control fluid at a lower temperature e.g. up to 40° C. The low-temperature pump 5 is likewise designed as a two-row orbiter eccentric piston pump.

Furthermore, the pump module 1 comprises an additional pump assembly 6. The additional pump assembly 6 is designed by way of example as a gerotor pump. The additional pump assembly 6 and the low-temperature pump 5 and the high-temperature pump 4 can be driven about a common drive axis A by means of a drive motor 7. Each orbiter eccentric piston pump has an eccentric shaft 8 which carries two eccentrics 9. Respective orbiter eccentric pistons 10 in pump chambers 11 are mounted on the eccentrics 9. The pump chambers 11 are separated by a respective separating wall 12. Therefore, in each case two pump chambers 11 separated by the separating wall 12 are formed in a common pump housing. As seen in a direction of rotation DR, the eccentrics 9 and the orbiter eccentric pistons 10 of a temperature control fluid pump unit 2 are phase-offset with respect to each other by 180° so that a two-row orbiter eccentric piston pump is formed.

The two temperature control fluid pump units 2, which are designed as orbiter eccentric piston pumps, are mechanically connected but hydraulically separated from each other by means of a separating wall component 13. For optimal thermal separation of the two temperature control fluid pump units 2, i.e. of the low-temperature pump 5 and of the high-temperature pump 4, the separating wall component 13 is formed from a material which has the lowest possible level of heat conductivity. The heat conductivity of the material from which the separating wall component 13 is produced is in particular lower than the heat conductivity of the pump housing forming the pump chambers 11.

In terms of construction, the low-temperature pump 5 is likewise designed as a two-row orbiter eccentric piston pump as described above with reference to the high-temperature pump 4.

In terms of axial succession it is particularly expedient to arrange—following the drive motor 7, which is designed e.g. as a brushless direct current motor (BLDC motor) 7—first the high-temperature pump 4, then the separating wall component 13, then the low-temperature pump 5 and then the additional pump assembly 6 which can be driven by a free end 14 of a drive shaft 15. In the exemplified embodiment according to FIG. 1, the drive shaft 15 is composed e.g. of two eccentric shafts 8 which are connected via a coupling 16 which can transmit torque.

Therefore, in the exemplified embodiment according to FIG. 1, both the high-temperature pump 4 and also the low-temperature pump 5 and the additional pump assembly 6 can be driven centrally by a drive motor 7. The high-temperature pump 4 provides high-temperature temperature control fluid for a high-temperature cooling circuit 40, in which e.g. the temperature control fluid valve means 3, e.g. one-way valves or multi-way valves, are disposed. The low-temperature pump 5 provides e.g. temperature control fluid at lower temperature compared to the high-temperature temperature control fluid. This low-temperature fluid is used e.g. for cooling a battery circuit (not shown). Such a low-temperature cooling circuit 50 contains e.g. rotary slide valves 17a, for instance as temperature control fluid valve means 3. Of course, said temperature control fluid valve means 3 in the respective cooling circuits 40, 50 are not limited to said types of valve construction.

A flow channel 17 leads from a pump chamber 11 of the low-temperature pump 5 to a fluid inlet of the additional pump assembly 6. The low-temperature fluid flowing through the flow channel 17 therefore serves as a control fluid 18 which is pumped by the additional pump assembly 6 and—as will be described hereinunder—serves to actuate at least one temperature control fluid valve means 3 with at least one pilot valve 20.

Following axially on from the low-temperature pump 5 and the additional pump assembly 6, a control unit ECU is set against the low-temperature pump 5 and is electrically connected to the drive motor 7 by means of a conductor channel 21 in which the electric conductors extend. The conductor channel 21 thus passes through the pump housing of the high-temperature pump 4 and of the low-temperature pump 5 and of the separating wall component 13.

The control unit ECU comprises a control board 30, on which, in a known manner, electronic circuits are disposed which serve to actuate the drive motor 7.

In the case of the embodiment in accordance with the invention according to FIG. 1, operating solenoids 31 of the pilot valves 20 are also disposed on the control board 30 and at that location are fastened directly on the surface of the control board 30 by means of SMD technology. SMD technology is to be understood to be surface-mount device technology in which electronic components are disposed and mounted directly on a surface of a circuit board.

Therefore, electric drive means of the pilot valves 20, which are the operating solenoids 31, are integrally disposed on the control board 30. Therefore, all singular plug connections for actuation of the operating solenoids 31 of the pilot valves 20 are omitted since these are already provided via the control board 30.

In the illustration according to FIG. 1, a total of four operating solenoids 31 for four pilot valves 20 are shown. The four pilot valves 20 can be mechanically held in a valve support and be used as a pilot valve module for mounting into the operating solenoids 31. Of course, the number of operating solenoids 31 is not limited to four but is naturally dependent on the number of pilot valves 20 to be actuated in the specific application.

The pilot valves 20 are connected to a pump output of the additional pump assembly 6. The control fluid 18 serves as a hydraulic supply fluid for the pilot valves 20. In accordance with the invention, the pilot valves 20 actuate, with the control fluid 18, the temperature control fluid valve means 3 which are larger in terms of their dimensions than the pilot valves 20.

A pump module 1 in accordance with the invention as described above can therefore be combined together with the pilot valves 20 and the temperature control fluid valve means 3 to form the temperature management system 100 while avoiding a multiplicity of conventionally required electric plug connections, this temperature management system as a whole also having a lower cabling outlay.

In the most favourable case, a single plug connection, which provides electric energy to drive the drive motor 7 and to supply the control unit ECU, will suffice for this purpose.

Accordingly, a lower cabling outlay for the temperature management system 100 results in simplified cable harnesses also being able to be used.

### LIST OF REFERENCE SIGNS

1 pump module

2 fluid pump unit/temperature control fluid pump unit

3 fluid valve means/temperature control fluid valve means

4 high-temperature pump

5 low-temperature pump

6 additional pump assembly

7 drive motor

8 eccentric shaft

9 eccentric

10 orbiter eccentric piston

11 pump chamber

12 separating wall

13 separating wall component

14 free end

15 drive shaft

16 coupling

17 flow channel

17a rotary slide valve

18 control fluid

20 pilot valve

21 conductor channel

30 control board

31 operating solenoid

40 high-temperature cooling circuit

50 low-temperature cooling circuit

100 temperature management system

A drive axis

ECU control unit

DR direction of rotation

1. A pump module, particularly a liquid fluid pump module for a temperature management system, e.g. of an electric battery-driven motor vehicle or of a hybrid motor vehicle, comprising:
at least one electrically driven fluid pump unit configured and provided to supply fluid to be pumped to at least one actuatable fluid valve means;
a control unit (ECU) for actuating at least one drive motor of the fluid pump unit,
characterized in that
the control unit (ECU) also comprises at least one electrically actuatable operating solenoid for a pilot valve, which solenoid is configured and provided to hydraulically operate the fluid valve means by means of the pilot valve during normal use of the pump module.

2. The pump module according to claim 1, wherein the fluid to be pumped is a liquid fluid, particularly a temperature control fluid.

3. The pump module according to claim 1, characterized in that there is furthermore an additional pump assembly that provides a control fluid having a control pressure.

4. The pump module according to claim 1, characterized in that the additional pump assembly may be driven by the drive motor of the fluid pump unit.

5. The pump module according to claim 3, characterized in that the additional pump assembly may be driven by a free end of a drive shaft of the fluid pump unit.

6. The pump module according to claim 1, characterized in that the control fluid is the pumped fluid and may be branched off from a fluid volume flow.

7. The pump module according to claim 1, characterized in that for branching off the control fluid there is a flow channel leading from a pump chamber of the fluid pump unit to the additional pump assembly.

8. The pump module according to claim 1, characterized in that at least the actuation solenoid is mounted directly on the control board of the control unit (ECU) by means of SMD mounting.

9. The pump module according to claim 1, characterized in that the pump module comprises at least one fluid pump unit provided as a low-temperature pump, particularly for the cooling of a battery cooling circuit, and a fluid pump unit provided as a high-temperature pump, particularly for cooling an inverter or a drive of a motor vehicle.

10. The pump module according to claim 1, characterized in that the at least one fluid pump unit is provided as an orbiter eccentric piston pump.

11. The pump module according to claim 1, characterized in that all fluid pump units are arranged coaxially around a common drive axis in a drivable manner.

12. A temperature management system at least comprising one pump module according to claim 1 and at least one fluid valve means which is operable by at least one pilot valve that is operable by the at least one operating solenoid.

13. A motor vehicle comprising a pump module according to claim 1, or a temperature management system according to claim 12.
